(19) United States
(12) Patent Application Publication
(10) Pub. No.: US 2026/0132648 A1
(43) Pub. Date: May 14, 2026

(54) POOL CLEANER WITH EDGE ENGAGEMENT ASSEMBLY

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 19/384,104

(22) Filed: Nov. 10, 2025

Related U.S. Application Data
(60) Provisional application No. 63/719,094, filed on Nov. 11, 2024.

(51) Int. Cl. E04H 4/16; C02F 1/00; C02F 103/42

(52) U.S. Cl. CPC E04H 4/1654; C02F 1/001; C02F 2103/42; C02F 2201/002; C02F 2201/008; C02F 2303/14

(57) ABSTRACT

A pool cleaner for a swimming pool or spa generally includes a body and an edge engagement assembly. The edge engagement assembly is pivotably connected to the pool cleaner such that the edge engagement assembly may pivot, slide or rotate between a stowed configuration and a deployed configuration. In the deployed configuration, the edge engagement assembly may extend forward from the front end of the body of the pool cleaner.

### REFERENCE TO RELATED APPLICATION

This application claims the benefit of and priority to U.S. Provisional Patent Application No. 63/719,094, filed on Nov. 11, 2024, and entitled POOL CLEANER WITH MOBILE HANDLE, the content of which is hereby incorporated by reference in its entirety.

### FIELD OF THE INVENTION

The invention relates to swimming pool cleaners for cleaning water-containing vessels such as swimming pools and spas.

### BACKGROUND OF THE INVENTION

Numerous cleaning devices capable of self-propelled autonomous or semi-autonomous movement within swimming pools and spas currently exist. The most common of these devices are automatic swimming pool cleaners, which often are either hydraulic pool cleaners or robotic pool cleaners. Hydraulic pool cleaners vary water flow for movement, while robotic pool cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. Pool cleaners may require periodic service or maintenance, such as to clean, replace, and/or otherwise service a filter of the pool cleaner. Commonly, a pool cleaner may move to a water line of the pool, and an end user must remove the pool cleaner from the pool to service the pool cleaner. For example, an end user may need to lean or bend towards the water line and lift the water-logged pool cleaner from the water, but such movement may be inconvenient and/or may be a safety risk to the user attempting to lift the pool cleaner, and an erroneous movement by the user may injure the end user, cause the end user to fall into the pool, and/or may damage the pool cleaner.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool cleaner includes a body and an edge engagement assembly. The edge engagement assembly is pivotably connected to the pool cleaner such that the edge engagement assembly is pivotable between a stowed configuration and a deployed configuration. In the deployed configuration, the edge engagement assembly extends forward from a front end of the body.

According to some embodiments, a pool cleaner includes a body and an edge engagement assembly. The edge engagement assembly includes a first arm connected to the pool cleaner and a transverse arm extending from a lateral side of the first arm. The edge engagement assembly is movable between stowed and deployed configurations relative to the body.

According to various embodiments, a pool cleaner includes a body and an edge engagement assembly. The edge engagement assembly is movable between stowed and deployed configurations relative to the body, and the edge engagement assembly further includes a sensor.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a pool cleaner having an edge engagement assembly according to embodiments.

FIGS. 2A-B illustrate the pool cleaner of FIG. 1 with the edge engagement assembly in a stowed configuration and a deployed configuration according to embodiments.

FIGS. 3A-B illustrate the pool cleaner of FIG. 1 with the edge engagement assembly connected to a filter of the pool cleaner and with the filter in an attached configuration and a detached configuration according to embodiments.

FIG. 4 illustrates a climbing movement of the pool cleaner of FIG. 1 according to embodiments.

FIG. 5 illustrates the pool cleaner of FIG. 1 on a wall of a pool of the pool system according to embodiments.

FIGS. 6A-C illustrate deployment of the edge engagement assembly of the pool cleaner of FIG. 1 according to embodiments.

FIG. 7 illustrates the pool cleaner of FIG. 1 with the edge engagement assembly in the deployed configuration according to embodiments.

FIGS. 8A-B illustrate the pool cleaner of FIG. 1 with the edge engagement assembly in the deployed configuration and removal of a filter of the pool cleaner according to embodiments.

FIGS. 9A-B illustrate a user removing the pool cleaner of FIG. 1 from the pool and handling the pool cleaner according to embodiments.

FIG. 10 illustrates another pool cleaner with an edge engagement assembly according to embodiments and with the edge engagement assembly in a deployed configuration.

FIG. 11 illustrates the pool cleaner of FIG. 10 with the edge engagement assembly in a stowed configuration.

FIG. 12 illustrates another pool cleaner with an edge engagement assembly according to embodiments and with the edge engagement assembly in a stowed configuration.

FIG. 13 is another view of the pool cleaner of FIG. 12 according to embodiments.

FIG. 14 illustrates the pool cleaner of FIG. 12 with the edge engagement assembly in a deployed configuration.

### DESCRIPTION OF THE INVENTION

Described herein are self-propelled pool cleaners for swimming pools, spas, and other recreational water vessels, the pool cleaners including one or more edge engagement assemblies.

In certain embodiments, the edge engagement assembly may be pivotably connected to the pool cleaner such that the edge engagement assembly may rotate between stowed and deployed configurations relative to a body of the pool cleaner. In the deployed configuration, the edge engagement assembly may extend and/or project forward from a front end of the body of the pool cleaner. In certain embodiments, the edge engagement assembly may be controlled to be in the deployed configuration when the pool cleaner is at a water line of the pool, and the edge engagement assembly in the deployed configuration may engage a ground or other surface at least partially surrounding the pool (e.g., a pool deck) and support the pool cleaner at the water line.

The edge engagement assembly may be selectively deployed or stowed automatically by the pool cleaner and/or responsive to a trigger event as desired. As non-limiting examples, the pool cleaner may deploy the edge engagement assembly at an end of a cleaning cycle of the pool cleaner and/or when the pool cleaner is at or proximate to a water line of the pool, responsive to a command from a user (e.g., via a user device), based on sensed information from one or more sensors (e.g., configured to detect a water line, a pressure corresponding to a water line, light, water, movement of the pool cleaner, a presence or absence of water, an engagement or handling of the pool cleaner by the user, a disengagement or release of the pool cleaner by the user, combinations thereof, etc.), combinations thereof, and/or as otherwise desired. As other non-limiting examples, the pool cleaner may stow the edge engagement assembly responsive to a command from a user, at the start of a cleaning cycle, based on sensed information from one or more sensors (e.g., a detected lowering movement of the pool cleaner, other detected movement, a detection of water, a detected contact or lack of contact by a user, a detected proximity, combinations thereof, etc.), combinations thereof, and/or as otherwise desired. In this regard, the pool cleaner may include various sensors as desired, such as but not limited to accelerometers, movement sensors, contact sensors, proximity sensors, water detection sensors, pressure sensors, light sensors, combinations thereof, and/or as otherwise desired.

Optionally, the pool cleaner may use the edge engagement assembly to stay at the waterline without energy consumption. As a non-limiting example, the edge engagement assembly, when deployed, may engage a pool edge and support and/or otherwise position the pool cleaner at a specific location within the pool without requiring energy consumption.

The edge engagement assembly may be stowed and deployed using various mechanisms or techniques as desired. Optionally, the edge engagement assembly is attachable to and detachable from the pool cleaner via one or more quick connect features, such as but not limited to a latch, a snap-fit connector, a button, combinations thereof, and/or as otherwise desired. In other embodiments, the edge engagement assembly need not be detachable and is instead fixedly attached or connected to the pool cleaner (e.g., the edge engagement assembly is not removable without disassembly).

In various embodiments, the edge engagement assembly includes at least one arm, and in various embodiments, the edge engagement assembly includes a plurality of arms, such as two arms. The at least one arm is configured to extend outwards from the pool cleaner in a deployed configuration. In embodiments with a plurality of arms, the arms may be connected to or detached from each other as desired. In various embodiments, each arm of the edge engagement assembly includes a first arm segment and a second arm segment, and the second arm segment extends at a non-zero angle relative to the first arm segment. In other embodiments, the arm may include one arm segment or more than two arm segments. In certain cases, the first arm segment may be the portion of the arm pivotably connected to the pool cleaner, and the second arm segment may be configured to engage the pool deck or other surface at least partially surrounding the pool when the pool cleaner is at the water line.

In some embodiments, in addition to the arm configured to extend away from the pool cleaner (e.g., with at least one arm segment, a first and second arm segment, etc.), the arm of the edge engagement assembly may include a transverse arm segment. Optionally, a transverse arm segment may connect opposing arms of the edge engagement assembly. However, in other embodiments, each arm includes a transverse arm segment. The transverse arm segment may extend from a lateral side of the second arm segment and/or such that the transverse arm is non-coplanar with the first arm segment and the second arm segment. In some cases, the transverse arm segment may be configured to engage the pool deck or other surface at least partially surrounding the pool when the pool cleaner is at the water line. An edge engagement assembly with an arm having the second arm segment and the transverse arm segment engaging the pool deck or other surface may provide improved stability and support of the pool cleaner at the water line.

In certain embodiments, the edge engagement assembly may be pivotably connected to the body of the pool cleaner and/or another component of the pool cleaner that generally remains assembled on the pool cleaner. In other embodiments, the edge engagement assembly may be pivotably connected to a removable component of the pool cleaner (e.g., which may be periodically removed for servicing), such as but not limited to a filter of the pool cleaner, a battery pack of the pool cleaner, combinations thereof, and/or as otherwise desired.

In some embodiments, the edge engagement assembly optionally includes a handle feature configured to be grabbed, held, or otherwise engaged by a user. In some cases, the handle feature may be provided on the second arm segment and/or the transverse arm segment. The handle feature may include a handle shape facilitating engagement by the user, such as but not limited to one or more notched or cutout sections, a portion of the arm having a reduced width or thickness, an opening configured to accommodate fingers of the user, a handle grip material or texture for slip prevention or improved friction engagement, combinations thereof, and/or other handle features as desired.

The edge engagement assembly with the handle feature may provide a solution allowing for improved removal of the cleaner (or sub-component, such as but not limited to a filter). In a non-limiting example, the edge engagement assembly may be integrated with a front extraction filter of the pool cleaner and/or may allow for removal of a front extraction filter while supporting the pool cleaner at a water line. In certain embodiments, the edge engagement assembly with the handle feature may allow for removal of a pool cleaner from a pool or spa without requiring the user to bend down and/or get their hand wet. In various embodiments, the handle may be used by the user to remove the pool cleaner from the pool, to transport the pool cleaner while out of the water of the pool or spa, to lower the pool cleaner into the pool from outside the pool or spa, and/or as otherwise desired. In some embodiments, the handle may be used to remove and/or deploy the entire cleaner. Additionally, or alternatively, the handle may be utilized to remove and/or deploy only a component or portion of the pool cleaner from the pool (e.g., a battery pack, filter, combinations thereof, etc.). Optionally, the edge engagement assembly (and/or another edge engagement assembly) may be connected to a filter onboard the pool cleaner and may be used by a user to remove the filter from the pool cleaner.

Various other benefits and advantages may be realized with the systems, devices, and methods provided herein, and the aforementioned advantages should not be considered limiting.

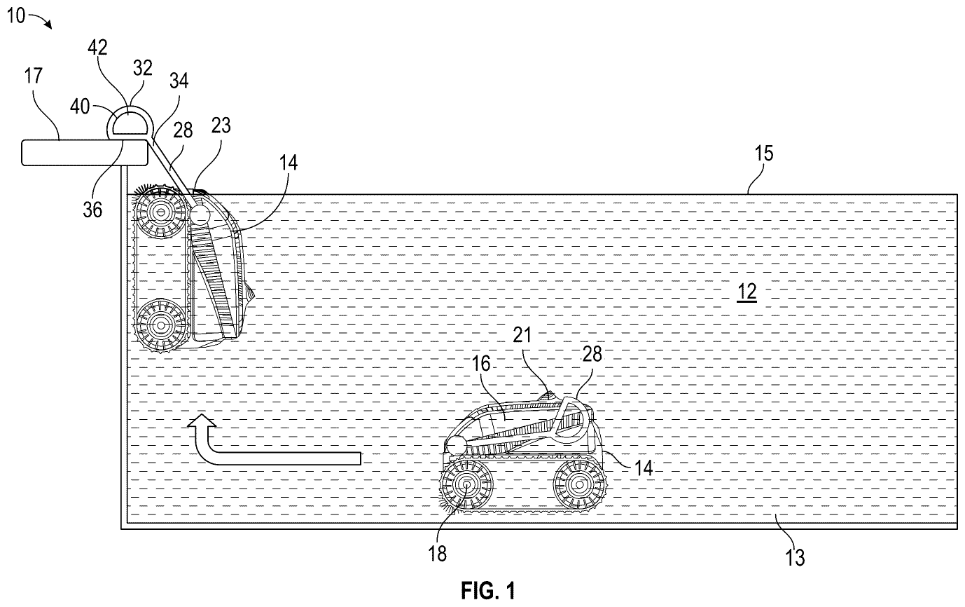

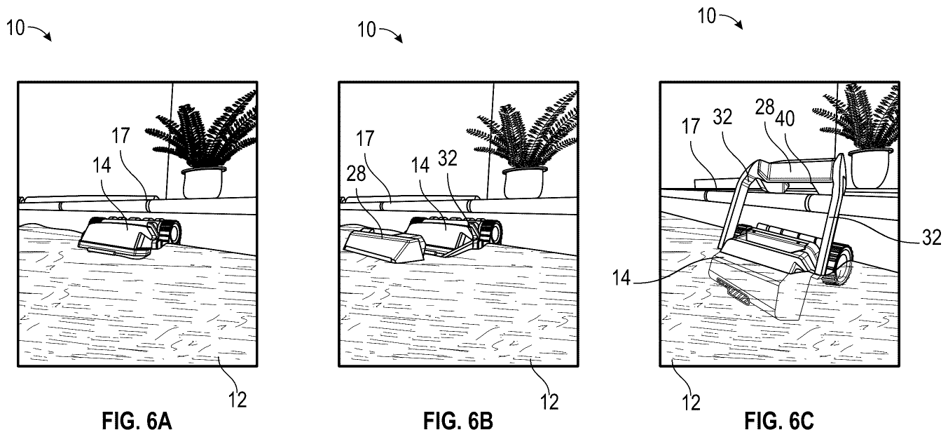

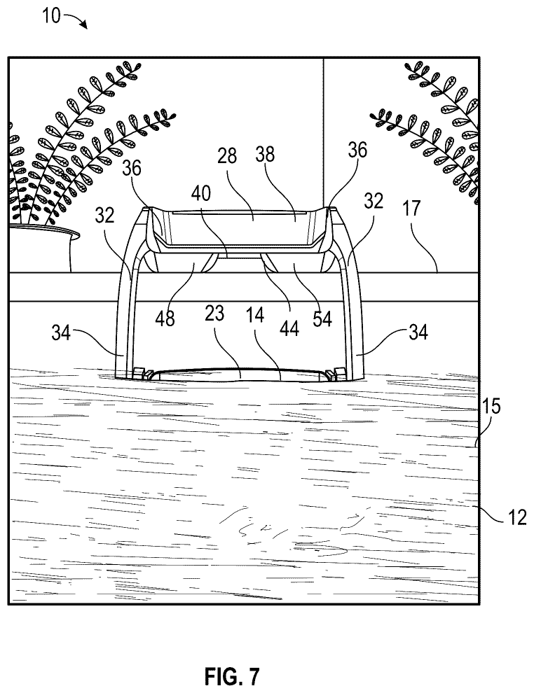

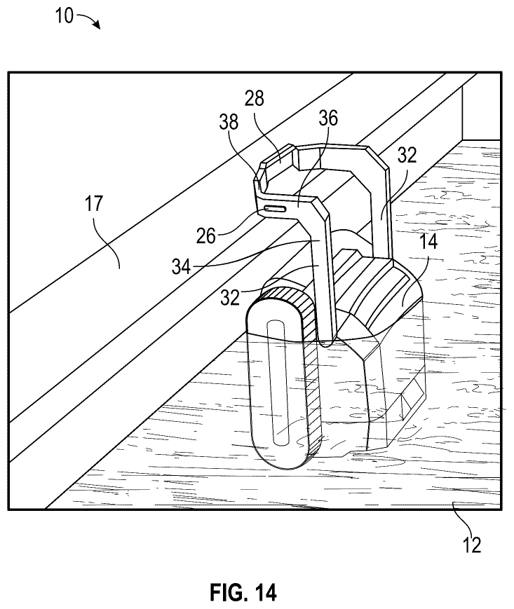

FIGS. 1-14 illustrate an example of a pool system 10 with a swimming pool or spa 12 (hereinafter “pool 12”) and one or more pool cleaners 14 according to embodiments.

The pool 12 may have various shapes, sizes, and dimensions, as desired, and those illustrated in FIG. 1 should not be considered limiting. In various embodiments, water 13 of the pool 12 includes a water line 15. A ground surface 17, such as but not limited to a pool deck, may at least partially surround the pool 12.

The pool cleaner 14 is a self-propelled pool cleaner which may be various types of cleaners capable of autonomous or semi-autonomous movement within the pool 12. The pool cleaner 14 generally include a housing or body 16 which generally includes a front end 23 and a back end 25. The body 16 may be in various shapes, sizes, and/or profiles as desired. The body 16 may be a one piece construction or a multi-piece construction as desired. As a non-limiting example, in some embodiments, the body 16 includes a chassis (e.g., supporting a motive device 18) and a housing attached to the chassis, optionally with the housing detachable from the chassis.

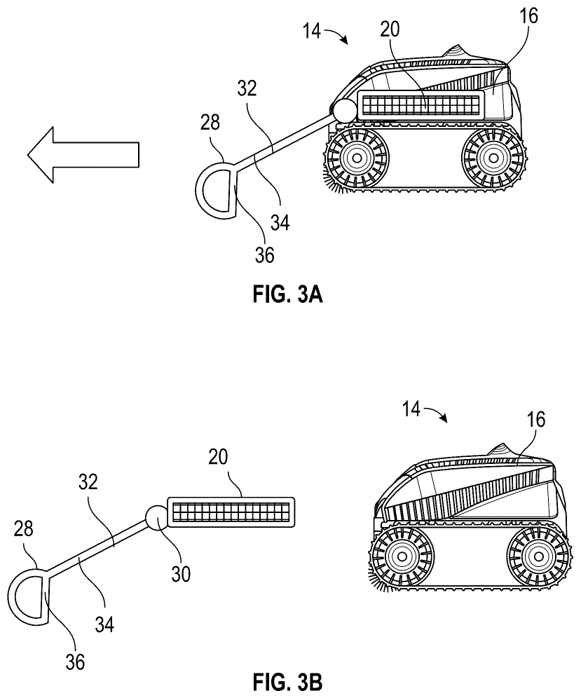

A filter 20 may be at least partially housed within the body 16, and the pool cleaner 14 includes one or more inlets and one or more outlets 21 such that debris-laden water may enter through the one or more inlets, with the filter 20 stopping or capturing at least some of the debris before allowing filtered water to exit the one or more outlets 21. In some embodiments, and as illustrated in FIGS. 3A-B and 8A-B, the filter 20 may be a front extraction filter 20 (e.g., removable in the direction of the front end 23). In such embodiments, and as described in detail below, an edge engagement assembly 28 may be utilized to remove the front extraction filter 20 and/or the edge engagement assembly 28 supporting the pool cleaner at a water line 15 may facilitate and allow for removal of the front extraction filter 20. In other embodiments, the filter 20 need not be a front extraction filter. In certain embodiments, the pool cleaner includes a pump within the body 16 for drawing water into the pool cleaner 14 and/or discharging water from the pool cleaner 14.

The pool cleaner 14 may include one or more motive devices 18 enabling movement of the pool cleaner 14 within the pool 12 and along a surface. As non-limiting examples, the one or more motive devices 18 may include one or more wheels, tracks, rollers, propellers, feet, combinations thereof, and/or other suitable devices as desired. In certain embodiments, the pool cleaner 14 may be a robotic cleaner using electrical power for movement and cleaning. In such embodiments, the pool cleaner 14 may include a motor which drives motive devices 18 such that the pool cleaner 14 navigates along a surface. In other embodiments, the pool cleaner 14 may be a hydraulic cleaner which controls water flow to propel the pool cleaner 14 along a surface.

In some embodiments, the pool cleaner 14 optionally includes a control system 22 (e.g., processor and/or memory), a brush assembly 24, an onboard power supply (e.g., one or more batteries), and/or one or more sensors 26 as desired.

The sensors 26 may be various sensors as desired, and any number and/or combination of sensors 26 may be included with the pool cleaner 14. The sensors 26 may detect various information about the pool cleaner 14 and/or about the operating environment of the pool cleaner 14. As non-limiting examples, the sensors 26 may detect one or more of a water line, a pressure, light, water, a proximity or distance, movement, a presence or absence, contact, a position of the edge engagement assembly 28, engagement or handling by a user, combinations thereof, and/or as otherwise desired. Accordingly, the sensors 26 may be various types of sensors 26, such as but not limited to accelerometers, movement sensors, contact sensors, proximity sensors, water detection sensors, pressure sensors, light sensors, combinations thereof, and/or as otherwise desired. Any number of sensors 26 may be utilized, and the sensors 26 may be provided on various portions of the pool cleaner 14 as desired. In a non-limiting example, at least one sensor 26 may be provided on an edge engagement assembly 28 of the pool cleaner. As a non-limiting example, the edge engagement assembly 28 may include a water sensor 26. Other configurations and arrangements of sensors 26 may be utilized as desired.

In certain embodiments, the pool cleaner 14 includes a communication module such that the pool cleaner 14 may communicate with an external device via various wired or wireless communication techniques. In the embodiment illustrated in FIG. 1, the pool cleaner 14 is a cordless pool cleaner 14 (e.g., with an onboard battery) and is configured to communicate via wireless communication. In other embodiments, a corded pool cleaner 14 (e.g., connected to an external power source via a cable or cord) may communicate via wired or wireless communication as desired.

The aforementioned features are for illustrative purposes, and in other embodiments, pool cleaners 14 may have additional and/or fewer components or features as desired. Non-limiting examples of other pool cleaners 14 may include those described in U.S. Pat. Nos. 10,316,534, 9,488,154, 8,578,538, and/or U.S. Patent Publication No. 2014/0303810, all of which are hereby incorporated by reference in their entireties. The number and type of pool cleaners 14 utilized with the pool system 10 should not be considered limiting.

As illustrated in FIG. 1, for example, the pool cleaner 14 generally includes an edge engagement assembly 28. The edge engagement assembly 28 may be connected to various portions or components of the pool cleaner 14 as desired. As non-limiting examples, the edge engagement assembly 28 may be connected to the body 16 of the pool cleaner 14 (or sub-component thereof such as but not limited to a chassis of the body 16, a housing of the body 16, a cover of the body 16, etc.), a filter of the pool cleaner 14, combinations thereof, and/or other components as desired. connected to the body 16 of the pool cleaner 14 (or sub-component thereof). As a non-

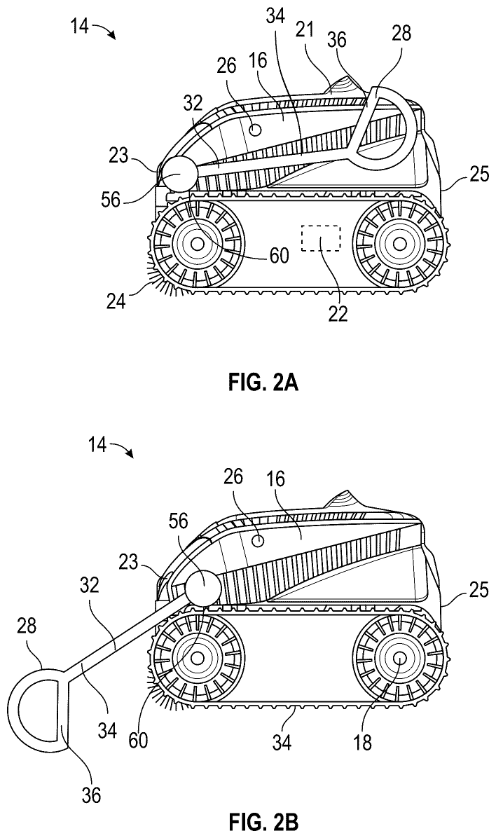

The edge engagement assembly 28 is movable relative to the body 16 of the pool cleaner 14 between a stowed configuration and a deployed configuration. In certain embodiments, the edge engagement assembly 28 is pivotably connected to the pool cleaner 14 such that the edge engagement assembly 28 may pivot or rotate between a stowed configuration (see, e.g., FIG. 2A) and a deployed configuration (see, e.g., FIG. 2B) and any position in-between. In other embodiments, the edge engagement assembly 28 may be movable between stowed and deployed configurations (and any position in-between) using other mechanisms or techniques as desired. As a non-limiting example, the edge engagement assembly 28 additionally or alternatively may be linearly movable relative to the body 16. In certain embodiments, and as described in detail below, in the deployed configuration, the edge engagement assembly 28 may be utilized to engage the ground surface 17 and support the pool cleaner 14 at the water line 15 and/or may be utilized by a user to lift and/or transport the pool cleaner 14.

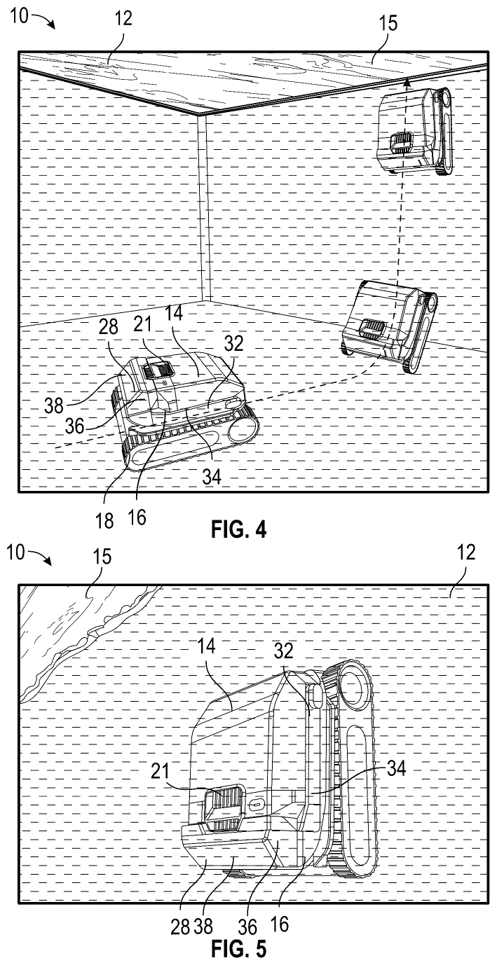

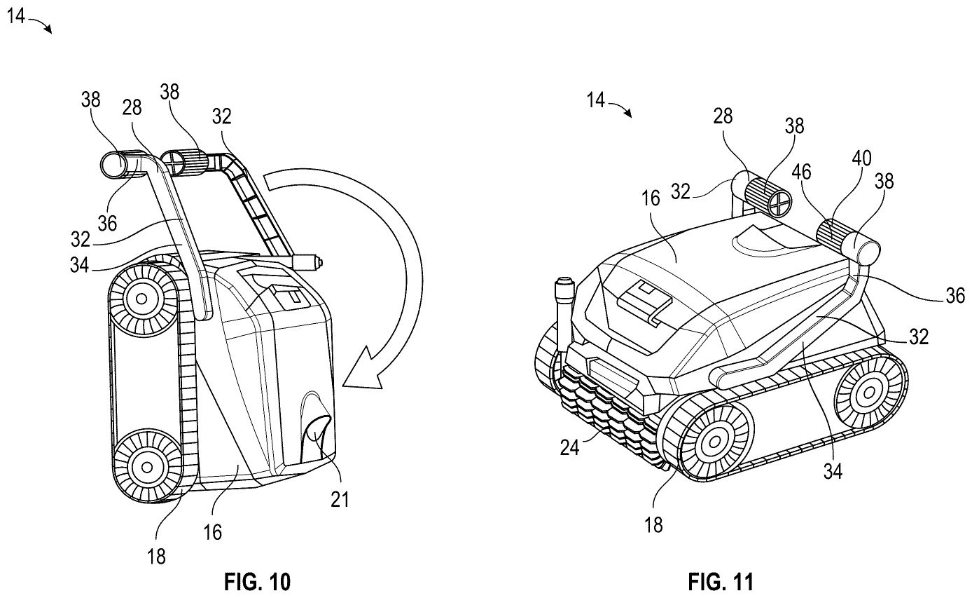

The edge engagement assembly 28 includes one or more arms 32. While a single arm 32 is illustrated in FIGS. 1 and 2A-B, in other embodiments, any number of arms 32 may be utilized. As non-limiting examples, FIGS. 4-14 illustrate the edge engagement assembly 28 with two arms 32. In embodiments with two or more arms 32, the arms 32 may be connected (see, e.g., FIGS. 4-9B and 12-14) or disconnected (see, e.g., FIGS. 10-11) as described in detail below. In a deployed configuration, the one or more arms 32 are configured to extend outwards and/or away from the pool cleaner 14.

Each arm 32 includes at least one arm segment, such as one arm segment, two arm segments, three arm segments, etc. Such arm segments may be a one-piece construction and/or integrally formed (e.g., portions of a same component) and/or may be discrete components connected together using devices or mechanisms as desired. In a non-limiting example, each arm 32 includes a first arm segment 34 and a second arm segment 36. The first arm segment 34 may be the portion of the arm 32 pivotably connected to the pool cleaner 14, and the second arm segment 36 may extend from the first arm segment 34. In certain embodiments, the second arm segment 36 extends at a non-zero angle relative to the first arm segment 34 such that the first and second arm segments 34, 36 are not co-linear. The second arm segment 36 extending at the angle relative to the first arm segment 34 may facilitate engagement of the edge engagement assembly 28 with a surface and/or by a user when the edge engagement assembly 28 is not in the stowed configuration.

In certain embodiments, and as illustrated in FIGS. 5, 6C, and 7, for example, the edge engagement assembly 28 optionally includes a transverse arm segment 38. Compared to the first and second arm segments 34, 36 (or generally the arm 32), the transverse arm segment may generally extend in a side-to-side direction and/or a direction between opposing lateral sides of the pool cleaner 14. In this regard, the transverse arm segment 38 may extend from a lateral side of the arm 32 (e.g., from the second arm segment 36 and/or the first arm segment 34) at an angle and/or such that the transverse arm segment 38 is not coplanar with the arm 32 (e.g., with the first arm segment 34 and/or the second arm segment 36). In embodiments where the edge engagement assembly 28 includes a plurality of arms 32, the transverse arm segment 38 optionally connects adjacent arms 32 as illustrated in FIGS. 5, 6C, and 7, for example. In other embodiments, and as illustrated in FIGS. 10 and 11, for example, the pool cleaner 14 may include a plurality of arms 32 where the arms 32 are disconnected, and each arm 32 includes a transverse arm segment 38. In such embodiments with a plurality of arms 32 that are disconnected, the arms 32 may be controlled to move between stowed and deployed configurations individually or jointly as desired.

In various embodiments, the arm 32 and/or the transverse arm segment 38 may include a handle feature 40 configured to be grabbed, held, or otherwise engaged by a user. FIGS. 1-3B illustrate the handle feature 40 on the second arm segment 36, and FIGS. 4-14 illustrate the handle feature 40 on the transverse arm segment 38. The handle feature 40 may include a handle shape facilitating engagement by the user, such as but not limited to an opening 42 configured to accommodate fingers of the user, one or more one or more notched or cutout sections 44, a portion of the arm having a reduced width or thickness, an extension of the second arm segment 36 and/or the transverse arm segment 38, a handle grip material 46 or texture for slip prevention or improved friction engagement, combinations thereof, and/or other handle features 40 as desired. Any number of handle features 40 may be utilized as desired, and various combinations of handle features 40 may be provided on an edge engagement assembly 28 as desired.

In some embodiments, the second arm segment 36 and/or the transverse arm segment 38 may include engagement features 48 configured to improve engagement and/or contact with a surface when the edge engagement assembly 28 is deployed. As non-limiting examples, engagement features 48 may include a material providing slip prevention and/or improved frictional engagement, such as but not limited to gripping ribs or material 46, bumpers 52, feet 54, combinations thereof, and/or as otherwise desired.

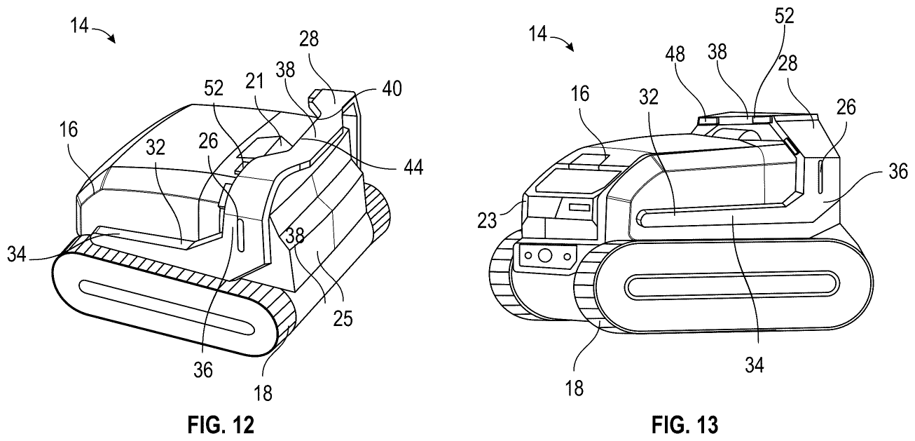

Optionally, and as illustrated in FIGS. 12 and 13 for example, one or more sensors 26 of the pool cleaner 14 may be provided on the edge engagement assembly 28. As non-limiting examples, one or more sensors 26 may be provided on the first arm segment 34, the second arm segment 36, and/or the transverse arm segment 38 as desired. The sensors 26 on the edge engagement assembly 28 may be various types of sensors as desired, such as but not limited to accelerometers, movement sensors, contact sensors, proximity sensors, water detection sensors, pressure sensors, combinations thereof, etc.

The edge engagement assembly 28 may be connected to various parts or components of the pool cleaner 14 as desired. As non-limiting examples, the edge engagement assembly 28 may be connected to the body 16 (see, e.g., FIGS. 1, 2A-B, and 4-14), connected to the filter (see, e.g., FIGS. 3A-B), connected to a cover of the pool cleaner 14, connected to a battery pack or module, combinations thereof, and/or as otherwise desired. In some embodiments, the edge engagement assembly 28 is fixedly attached to the pool cleaner 14, meaning that the edge engagement assembly 28 is not removable or detachable without disassembly of the pool cleaner 14. Alternatively, the edge engagement assembly 28 is removable or detachable from the pool cleaner 14, optionally utilizing one or more quick connect features 62. Non-limiting examples of quick connect features 62 include, but are not limited to, a latch, a magnet, a spring, a snap-fit connector, a button, combinations thereof, and/or as otherwise desired. In other embodiments, the edge engagement assembly 28 may be connected to the pool cleaner 14 using other components, devices, or mechanisms as desired.

As mentioned, the edge engagement assembly 28 is movable relative to the pool cleaner 14, and thus the edge engagement assembly 28 may be connected to the pool cleaner 14 using various devices, mechanisms, or components enabling movement of the edge engagement assembly 28. The edge engagement assembly 28 may be movable relative to the pool cleaner 14 using various types of movement. As non-limiting examples, the edge engagement assembly 28 may be pivotable relative to the pool cleaner 14, slidable relative to the pool cleaner 14, rotatable about a plurality of axes, combinations thereof, and/or utilize other movement as desired.

As illustrated in FIGS. 2B, 6C, and 7, for example, in the deployed configuration, the edge engagement assembly 28 generally extends forward from the front end 23 of the pool cleaner 14. By extending forward from the front end 23, the edge engagement assembly 28 in the deployed configuration may be utilized to engage the ground surface 17 and support the pool cleaner 14 at the water line 15 and/or may be utilized by a user to lift and/or transport the pool cleaner 14. Optionally, the edge engagement assembly 28 in the deployed configuration may be utilized to support the pool cleaner 14 at the water line 15 without requiring energy consumption by the pool cleaner 14. In other embodiments, the edge engagement assembly 28 may be utilized to support the pool cleaner 14 while requiring energy consumption.

In the stowed configuration, the second arm segment(s) 36 of the edge engagement assembly 28 may be proximate to the body 16 (e.g., on the body 16, near the body 16, within the housing 16, combinations thereof, etc.), and in the deployed configuration, the second arm segment(s) 36 of the edge engagement assembly 28 may be spaced apart from the body 16. Optionally, in the stowed configuration, the second arm segment(s) 36 of the edge engagement assembly 28 may be positioned aft (or rear) of a pivot location 56 and aft of the front end 23 of the pool cleaner 14, and in the deployed configuration, the arm segment(s) 36 of the edge engagement assembly 28 may be positioned forward of the pivot location 56 and/or forward of the front end 23 of the pool cleaner 14. Optionally, and as illustrated in FIGS. 2A-B, in the stowed configuration, the second arm segment(s) 36 of the edge engagement assembly 28 may be positioned above motive devices 18 and/or above a bottom end of the pool cleaner 14, and in the deployed configuration, the second arm segment(s) 36 of the edge engagement assembly 28 may be positioned at least partially below the motive devices 18 and/or the bottom end. In other embodiments, the edge engagement assembly 28 may have other positions and/or orientations relative to other components, and these examples should not be considered limiting.

The pool cleaner 14 may include one or more control devices 60 for automatically moving the edge engagement assembly 28 between the stowed and deployed configurations and such that the edge engagement assembly 28 is actuated. The control devices 60 may be various devices, systems, and/or mechanisms as desired. As non-limiting examples, the one or more control devices 60 may include one or more motors, one or more springs or biasing members, one or more magnets, other types of actuators, combinations thereof, and/or as otherwise desired.

In some embodiments, the edge engagement assembly 28 may by automatically moved and/or may be manually moved as desired. In embodiments where the edge engagement assembly 28 is automatically moved between the stowed configuration and the deployed configuration (and/or vice versa and/or to an intermediate position), the edge engagement assembly 28 may be controlled responsive to a command from a user, based on information from a sensor 26, and/or responsive to various inputs or trigger events as desired. As non-limiting examples, the edge engagement assembly 28 may be automatically deployed at the end of a cleaning cycle by the pool cleaner 14, based on a command or input received from a user on a user device or a remote device, based on a power status of an onboard power source, based on a filter status, based on a time of day, based on an operational schedule of the pool cleaner 14, based on a location of the pool cleaner 14 in the pool 12, combinations thereof, and/or as otherwise desired.

As a non-limiting example, the end of the cleaning cycle and/or the position of the pool cleaner 14 may be obtained and/or determined based on sensor data, operation of other components of the pool cleaner, etc., and the edge engagement assembly 28 may be automatically stowed or deployed based on such data. As an example, responsive to the pool cleaner 14 ending a cleaning cycle and climbing a wall of the pool 12 to be at the water line 15, the edge engagement assembly 28 may be automatically deployed. In such embodiments, the pool cleaner 14 may detect and/or sense the water line 15 (thereby causing the edge engagement assembly 28 to deploy) based on data from a sensor 26, such as but not limited to accelerometers, movement sensors, contact sensors, proximity sensors, water detection sensors, pressure sensors, combinations thereof, etc. As another non-limiting example, a sensor 26 of the pool cleaner 14 may detect vertical movement of the pool cleaner 14 and/or a removal of contact by a user (e.g., indicating a user may have lowered the pool cleaner 14 into the pool after handling the pool cleaner 14), and based on such sensor data, the edge engagement assembly 28 may automatically move to the stowed configuration. In such embodiments, in addition to stowing the edge engagement assembly 28, the pool cleaner 14 optionally may automatically start a cleaning cycle. As another non-limiting example, responsive to the filter 20 being full as detected by a sensor 26 and optionally a positioning of the pool cleaner 14 at the water line 15, the edge engagement assembly 28 may be automatically deployed.

As further non-limiting examples, the edge engagement assembly 28 may be automatically stowed or deployed responsive to an input from a user on a remote device, which may be wirelessly and/or otherwise communicated to the pool cleaner 14. As a non-limiting example, a pool cleaner 14 at the water line 15 may automatically deploy the edge engagement assembly 28 responsive to input from a user on the user device. As another non-limiting example, the pool cleaner 14 at the water line 15 and with the edge engagement assembly 28 deployed and in engagement with the surface 17 may automatically stow the edge engagement assembly 28 responsive to input from a user (thereby allowing the pool cleaner 14 to optionally submerge itself within the pool).

As mentioned, in the deployed configuration, the edge engagement assembly 28 may be deployed such that the second arm segment(s) 36 and/or the transverse arm segment(s) 38 engage the surface 17 adjacent or proximate to an edge of the pool 12, optionally without requiring energy consumption by the pool cleaner 14. In some embodiments, the edge engagement assembly 28 may be utilized to remove the entire pool cleaner 14 from the water, or deploy the pool cleaner 14 within the water.

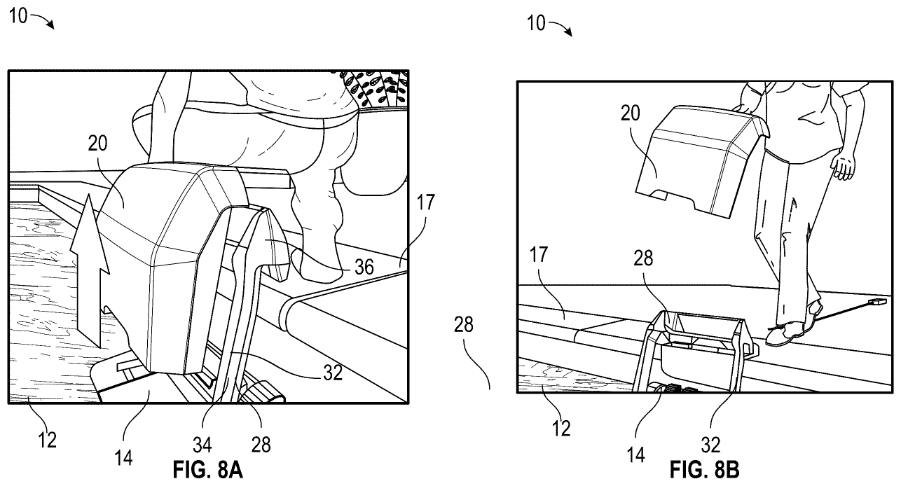

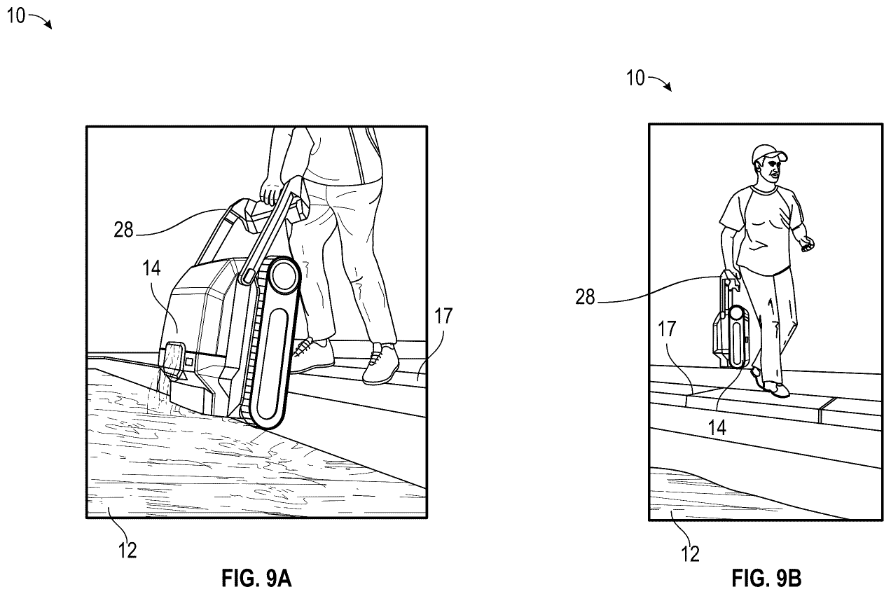

Additionally, or alternatively, the edge engagement assembly 28 may be utilized to remove and/or deploy a sub-component of the pool cleaner 14. As a non-limiting example, as illustrated in FIGS. 9A-B, the edge engagement assembly 28 itself may be handled by a user. Additionally, or alternatively, such a configuration may support the pool cleaner 14 such that a sub-component of the pool cleaner 14 may be removed or detached as desired. As a non-limiting example, FIGS. 8A-B illustrate removal or detachment of the filter 20 while the pool cleaner 14 is supported at the water line 15 by the edge engagement assembly 28. As non-limiting examples, the edge engagement assembly 28 may be utilized to remove only a battery pack or module, the filter 20, combinations thereof, and/or other sub-components as desired without removing the entire pool cleaner 14. In the embodiment of FIGS. 8A-B, the filter 20 is a front extraction filter, and the edge engagement assembly 28 supporting the pool cleaner at the water line 15 facilitates removal of the front extraction filter 20 from the pool cleaner 14 as desired. As another non-limiting example, FIGS. 3A-B illustrate the edge engagement assembly 28 integrated or connected to the filter 20, which may be a front extraction filter, and the edge engagement assembly 28 may be utilized to remove the front extraction filter 20.

In certain embodiments, operation of the edge engagement assembly 28 may be integrated and/or coordinated with other operations of the pool cleaner 14 to provide improved handling and control of the pool cleaner 14. As a non-limiting example, as the edge engagement assembly 28 is deployed, a control system of the pool cleaner may cause activation of the motive elements 18 and/or water exhaust to propel the pool cleaner 14 forward, which may facilitate initial engagement of the edge engagement assembly 28 with the surface 17 by “pushing” the pool cleaner 14 upwards at the water line 15 to help lift the pool cleaner 14 out of the water. In some embodiments, after a trigger event, the cleaner with the edge engagement assembly deployed may perform a specific “motor” sequence to help the user to remove the cleaner from the water, thereby providing a lift system. The trigger event may be any trigger event as desired. In a non-limiting example, the trigger event for initiating the motor sequence to help lift the pool cleaner 14 may include a button, accelerometer, combinations thereof, and/or as otherwise desired.

As another non-limiting example, responsive to a sensor of the edge engagement assembly 28 detecting a vertical movement of the edge engagement assembly 28 and/or contact or a lifting movement by a user, a control system of the pool cleaner 14 may cause activation of the motive elements 18 and/or water exhaust to propel the pool cleaner 14 upwards, thereby facilitating removal or lifting of the pool cleaner 14 from the pool. As another non-limiting example, responsive to a sensor of the edge engagement assembly 28 detecting a downwards vertical movement and/or a disengagement by a user, a control system of the pool cleaner 14 may cause the edge engagement assembly 28 to stow while also causing rearward activation of the motive elements 18 to facilitate submergence of the pool cleaner 14 into the pool.

Various other controls may be implemented as desired, and the aforementioned examples should not be considered limiting.

Pool cleaners with the mobile handles described herein provide a solution allowing for easy removal of a pool cleaner from water of a swimming pool or spa and/or removal of a filter from the pool cleaner. Various other combinations of features may be utilized as desired, and the aforementioned examples should not be considered limiting.

Exemplary concepts or combinations of features of the invention may include:
A. A pool cleaner comprising a body and an edge engagement assembly, wherein the edge engagement assembly is movably connected to the pool cleaner such that the edge engagement assembly can be moved between a stowed configuration and a deployed configuration.
B. The pool cleaner of any preceding or subsequent statement or combination of statements, wherein the edge engagement assembly is pivotably connected to the pool cleaner such that the edge engagement assembly is pivotable between the stowed configuration and the deployed configuration.
C. A pool cleaner comprising a body and an edge engagement assembly, wherein the edge engagement assembly comprises wherein the edge engagement assembly comprises an arm pivotably connected to the pool cleaner, wherein the arm comprises a first arm segment and a second arm segment connected to the first arm segment, wherein the second arm segment extends at a non-zero angle relative to the first arm segment.
D. A pool cleaner comprising a body and an edge engagement assembly, wherein the edge engagement assembly comprises a first arm connected to the pool cleaner and a transverse arm extending from a lateral side of the first arm, wherein the edge engagement assembly is movable between stowed and deployed configurations relative to the body.
E. A pool cleaner comprising a body and an edge engagement assembly, wherein the edge engagement assembly is movable between stowed and deployed configurations relative to the body, and wherein the edge engagement assembly further comprises a sensor.
F. The pool cleaner of any preceding or subsequent statement or combination of statements, wherein the edge engagement assembly is configured to be grabbed by a user.
G. The pool cleaner of any preceding or subsequent statement or combination of statements, wherein the edge engagement assembly is movable in response to a trigger event.
H. The pool cleaner of any preceding or subsequent statement or combination of statements, where the trigger event is an end of a cleaning cycle of the pool cleaner, the pool cleaner sensing a waterline or a pressure corresponding to the water line, and/or the pool cleaner receiving a signal from a user or other remote device.
I. The pool cleaner of any preceding or subsequent statement or combination of statements, wherein, when the edge engagement assembly is deployed at a water line of a pool, the edge engagement assembly engages an above-water surface relative to a pool to position the pool cleaner relative to the water line without requiring energy consumption.
J. The pool cleaner of any preceding or subsequent statement or combination of statements, wherein, when the edge engagement assembly is deployed at a water line of a pool, the edge engagement assembly engages an above-water surface relative to a pool to position the pool cleaner relative to the water line and requiring energy consumption.
K. The pool cleaner of any preceding or subsequent statement or combination of statements, wherein the edge engagement assembly is detachable from the pool cleaner.
L. The pool cleaner of any preceding or subsequent statement or combination of statements, wherein the edge engagement assembly is connected to the body of the pool cleaner.
M. The pool cleaner of any preceding or subsequent statement or combination of statements, wherein the edge engagement assembly is connected to a filter of the pool cleaner or other sub-component of the pool cleaner.
N. The pool cleaner of any preceding or subsequent statement or combination of statements, further comprising a control device for moving the edge engagement assembly, the control device comprising one or more of a motor, a spring, a magnet, combinations thereof, and/or as otherwise desired.
O. The pool cleaner of any preceding or subsequent statement or combination of statements, wherein the edge engagement assembly is fixedly attached to the pool cleaner.
P. The pool cleaner of any preceding or subsequent statement or combination of statements, wherein the edge engagement assembly is configured to be grabbed by a user out of water of the pool or spa to remove the pool cleaner from the pool or spa.
Q. The pool cleaner of any preceding or subsequent statement or combination of statements, wherein the edge engagement assembly is configured to be engaged by a user to remove the entire pool cleaner from the pool or spa.
R. The pool cleaner of any preceding or subsequent statement or combination of statements, wherein the edge engagement assembly is configured to allow a user to remove a sub-component of the pool cleaner from the pool or spa without removing the entire pool cleaner.
S. The pool cleaner of any preceding or subsequent statement or combination of statements, wherein the sub-component comprises a battery pack, a filter, combinations thereof, and/or as otherwise desired.
T. The pool cleaner of any preceding or subsequent statement or combination of statements, wherein the pool cleaner comprises one or more sensors, and wherein the edge engagement assembly is movable based on information from the one or more sensors.
U. The pool cleaner of any preceding or subsequent statement or combination of statements, wherein the edge engagement assembly comprises a first arm pivotably connected to the pool cleaner and a second arm connected to the first arm, wherein the second arm extends at a non-zero angle relative to the first arm.
V. The pool cleaner of any preceding or subsequent statement or combination of statements, wherein the edge engagement assembly further comprises a transverse arm extending from a lateral side of the second arm.
W. The pool cleaner of any preceding or subsequent statement or combination of statements, wherein the edge engagement assembly further comprises a sensor.
X. The pool cleaner of any preceding or subsequent statement or combination of statements, wherein the edge engagement assembly comprises a first arm connected to the pool cleaner and a transverse arm extending from a lateral side of the first arm.
Y. The pool cleaner of any preceding or subsequent statement or combination of statements, wherein the first arm is connected to the body, and wherein, in the deployed configuration, the transverse arm is positioned forward from a front end of the body.
Z. The pool cleaner of any preceding or subsequent statement or combination of statements, wherein the edge engagement assembly further comprises a handle feature.
AA. The pool cleaner of any preceding or subsequent statement or combination of statements, wherein, in the deployed configuration, the edge engagement assembly extends forward from a front end of the body of the pool cleaner.
BB. The pool cleaner of any preceding or subsequent statement or combination of statements, further comprising a front extraction filter, and wherein the front extraction filter is removable from the pool cleaner when the edge engagement assembly is in the deployed configuration.
CC. The pool cleaner of any preceding or subsequent statement or combination of statements, wherein, after and/or responsive to a trigger event, the pool cleaner with the edge engagement assembly deployed performs a motor sequence to help lift the pool cleaner at the water line to help a user to remove the pool cleaner from water.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although devices and techniques have been described for use principally with pool cleaners, the features described herein may be utilized in connection with other objects and in other manners. Finally, references to “pools” and “swimming pools” herein may also refer to spas or other water containing vessels used for recreation, training, or therapy and for which cleaning of debris is needed or desired.

That which is claimed:

1. A pool cleaner comprising:
a body; and
an edge engagement assembly, wherein the edge engagement assembly is pivotably connected to the pool cleaner such that the edge engagement assembly is pivotable between a stowed configuration and a deployed configuration, and wherein, in the deployed configuration, the edge engagement assembly extends forward from a front end of the body.

2. The pool cleaner of claim 1, wherein the edge engagement assembly comprises an arm pivotably connected to the pool cleaner, wherein the arm comprises a first arm segment and a second arm segment extending from the first arm segment, wherein the second arm segment extends at a non-zero angle relative to the first arm segment.

3. The pool cleaner of claim 2, wherein the edge engagement assembly further comprises a transverse arm extending from a lateral side of the arm.

4. The pool cleaner of claim 1, wherein the edge engagement assembly further comprises a sensor.

5. The pool cleaner of claim 1, wherein the edge engagement assembly comprises a first arm connected to the pool cleaner and a transverse arm extending from a lateral side of the first arm.

6. The pool cleaner of claim 1, wherein the edge engagement assembly is movable responsive to a trigger event.

7. The pool cleaner of claim 6, where the trigger event is an end of a cleaning cycle of the pool cleaner, the pool cleaner sensing a waterline or a pressure corresponding to the water line, and/or the pool cleaner receiving a signal from a user or other remote device.

8. A pool cleaner comprising:
a body; and
an edge engagement assembly, wherein the edge engagement assembly comprises a first arm connected to the pool cleaner and a transverse arm extending from a lateral side of the first arm, wherein the edge engagement assembly is movable between stowed and deployed configurations relative to the body.

9. The pool cleaner of claim 8, wherein the first arm is connected to the body, and wherein, in the deployed configuration, the transverse arm is positioned forward from a front end of the body.

10. The pool cleaner of claim 8, wherein the edge engagement assembly further comprises a sensor.

11. The pool cleaner of claim 8, wherein the edge engagement assembly further comprises a second arm connecting the first arm and the transverse arm, wherein the second arm extends at a non-zero angle relative to the first arm.

12. The pool cleaner of claim 8, wherein the edge engagement assembly is movable responsive to a trigger event.

13. The pool cleaner of claim 12, where the trigger event is an end of a cleaning cycle of the pool cleaner, the pool cleaner sensing a waterline or a pressure corresponding to the water line, and/or the pool cleaner receiving a signal from a user or other remote device.

14. The pool cleaner of claim 8, wherein the edge engagement assembly further comprises a handle feature.

15. A pool cleaner comprising:
a body; and
an edge engagement assembly, wherein the edge engagement assembly is movable between stowed and deployed configurations relative to the body, and wherein the edge engagement assembly further comprises a sensor.

16. The pool cleaner of claim 15, wherein the edge engagement assembly is movable based on information from the sensor.

17. The pool cleaner of claim 15, wherein the edge engagement assembly is pivotable between the stowed and deployed configurations.

18. The pool cleaner of claim 15, wherein the edge engagement assembly comprises a first arm pivotably connected to the pool cleaner and a second arm connected to the first arm, wherein the second arm extends at a non-zero angle relative to the first arm.

19. The pool cleaner of claim 15, further comprising a front extraction filter, and wherein the front extraction filter is removable from the pool cleaner when the edge engagement assembly is in the deployed configuration.

20. The pool cleaner of claim 15, wherein the edge engagement assembly further comprises a handle feature.
